(19) United States
(12) Patent Application Publication
(10) Pub. No.: US 2025/0130320 A1
(43) Pub. Date: Apr. 24, 2025

(54) DETECTION CIRCUIT FOR LASER RADAR, LASER RADAR, VEHICLE SYSTEM, AND METHOD

(71) Applicant: TUDATONG (SUZHOU) CO., LTD., SUZHOU (CN)

(72) Inventors: Quanwei SONG, SUZHOU (CN); Yanjun WANG, SUZHOU (CN); Ran LIU, SUZHOU (CN); Yunzhong WANG, SUZHOU (CN); Rui WANG, SUZHOU (CN); Anxiao YE, SUZHOU (CN)

(73) Assignee: TUDATONG (SUZHOU) CO., LTD., SUZHOU, JS (CN)

(21) Appl. No.: 18/923,543

(22) Filed: Oct. 22, 2024

(30) Foreign Application Priority Data
Oct. 23, 2023 (CN) 202311376712.9

(51) Int. Cl. G01S 7/497; G01S 7/481; G01S 17/93; G02B 26/10

(52) U.S. Cl. CPC G01S 7/497; G01S 7/4817; G01S 17/93; G02B 26/105

(57) ABSTRACT

Provided in the present disclosure are a detection circuit for LiDAR system and system and methods for LiDAR and vehicle systems. The detection circuit includes: an input terminal configured to receive a first signal for representing position information of a motor or an optical redirecting element; an output terminal configured to be connected to a laser; a detection signal generation unit configured to generate a detection signal based on the first signal; and a control unit configured to determine whether the motor or the optical redirecting element fails based on a comparison between the detection signal and a preset signal threshold, and output a control signal via the output terminal to control the laser. The accuracy and reliability of fault detection of optical redirecting element are achieved.

### CROSS REFERENCE TO RELATED APPLICATIONS

This application s priority to Chinese application number 202311376712.9 filed on Oct. 23, 2023. The entire content of this application is hereby incorporated herein by reference in its entirety for all purposes.

### TECHNICAL FIELD

The present disclosure relates to the field of Light Detection and Ranging (LiDAR) systems, and more specifically to a detection circuit for a LiDAR system and a vehicle system.

### BACKGROUND

In autonomous driving and intelligent transportation technologies, the LiDAR system is becoming an indispensable and important technical component. Taking autonomous driving as an example, it is realized on the premise of good on-site perception and detection functions for virtual-real interaction. At present, most of vehicle integration solutions for autonomous driving are based on multi-sensor fusion detection and complementary or fusion processing of multi-sensor data collected at the same time point at the algorithm level.

The methods described in this section are not necessarily those that have been previously envisioned or adopted. Unless otherwise indicated, none of the methods described in this section should be assumed to be the prior art merely because they are included in this section. Similarly, unless otherwise indicated, the problems mentioned in this section should not be considered as having been recognized in any prior art.

### SUMMARY

According to a first aspect of embodiments of the present disclosure, a detection circuit for a LiDAR system is provided. The LiDAR system includes a laser, an optical redirecting element, and a motor. The detection circuit includes: an input terminal configured to receive a first signal for representing position information of a motor or an optical redirecting element; an output terminal configured to be connected to a laser; a detection signal generation unit configured to generate a detection signal based on the first signal; and a control unit configured to determine whether the motor or the optical redirecting element fails based on a comparison between the detection signal and a preset signal threshold, and output a control signal via the output terminal to control the laser.

According to a second aspect of embodiments of the present disclosure, a LiDAR system is provided, including the detection circuit above.

According to a third aspect of embodiments of the present disclosure, a vehicle system is provided, including the LiDAR system above.

According to a fourth aspect of embodiments of the present disclosure, a method for controlling a LiDAR system is provided. The LiDAR system includes a laser, an optical redirecting element, and a motor. The method includes: acquiring a first signal for representing rotational position information of the motor or the optical redirecting element; determining an operating state of the motor or the optical redirecting element based on the first signal; and controlling the laser based on the operating state.

According to one or more embodiments of the present disclosure, the accuracy and reliability of fault detection of the optical redirecting element of the LiDAR system can be achieved.

### BRIEF DESCRIPTION OF THE DRAWINGS

The drawings exemplarily illustrate embodiments and constitute part of the specification, and together with the textual description of the specification, serve to illustrate exemplary implementations of the embodiments. The embodiments shown are for illustrative purposes only and do not limit the scope of claims. In all the drawings, the same reference numerals refer to the same elements or similar but not necessarily identical elements.

FIG. 1 is a schematic block diagram illustrating a detection circuit for a LiDAR system according to some embodiments of the present disclosure;

FIG. 2 is a schematic circuit diagram illustrating a detection circuit for a LiDAR system according to some embodiments of the present disclosure;

FIG. 3 is a schematic circuit diagram illustrating a detection circuit for a LiDAR system according to some other embodiments of the present disclosure;

FIG. 4 is a schematic block diagram illustrating a detection circuit for a LiDAR system according to some other embodiments of the present disclosure;

FIG. 5 is a schematic circuit diagram illustrating a detection circuit for a LiDAR system according to some other embodiments of the present disclosure;

FIG. 6 is a schematic diagram illustrating a LiDAR system to which a detection circuit according to an embodiment of the present disclosure can be applied;

FIG. 7A and FIG. 7B are diagrams illustrating curves of output voltages and time of a galvanometer motor of the LiDAR system in FIG. 6 in two working modes;

FIGS. 8A-8C are schematic diagrams of simulation results of the detection circuit for the LiDAR system shown in FIG. 2;

FIG. 9 is a schematic diagram illustrating a vehicle system including a centralized laser transmission system and a LiDAR system according to an embodiment of the present disclosure; and

FIG. 10 is a schematic block diagram illustrating a method for controlling a laser of a LiDAR system according to an embodiment of the present disclosure.

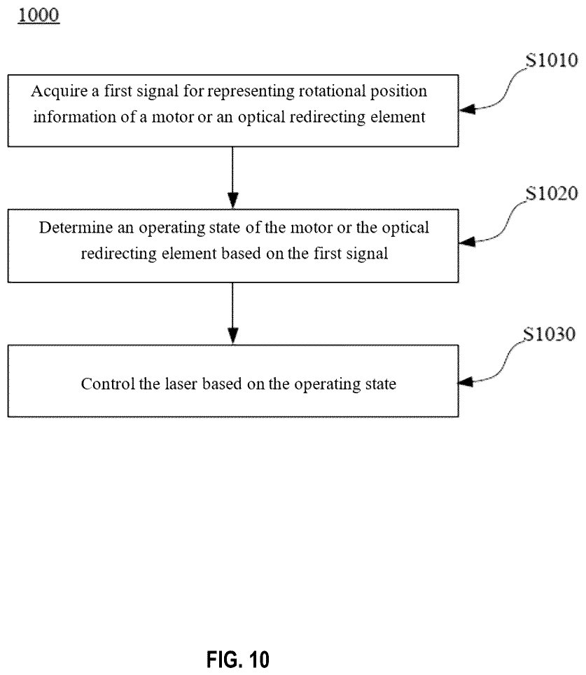

### DETAILED DESCRIPTION OF THE EMBODIMENTS

Further detailed description of the present disclosure will be provided below in conjunction with the drawings and embodiments. It can be understood that the specific embodiments described herein are merely to illustrate the related invention, and are not intended to limit the invention. Additionally, it should be noted that for ease of description, only parts related to the related invention are shown in the drawings.

It should be noted that the embodiments of the present disclosure and the features in the embodiments may be combined with each other unless without conflict. Unless otherwise explicitly stated in the context, if the number of elements is not specifically limited, the element can be one or plural. In addition, the numbers of steps or functional modules used in the present disclosure are only used to identify each step or functional module, and are not used to limit the execution order of each step or the connection relationship between each functional module.

In the present disclosure, unless otherwise specified, the use of the terms “first”, “second”, etc. to describe various elements is not intended to define the positional relationship, temporal relationship, or importance relationship of these elements, and such terms are simply used to distinguish one element from another element. In some examples, the first element and the second element may refer to the same instance of the element, while in some cases, they may also refer to different instances based on contextual descriptions.

In the present disclosure, the terms used in the description of various described examples are for the purpose of describing specific examples only, and are not intended to be limiting. Unless otherwise explicitly stated in the context, if the number of elements is not specifically limited, the element can be one or plural. In addition, the term “and/or” used in the present disclosure encompasses any one and all possible combinations of the listed items.

“LiDAR system” (LiDAR system) refers to a radar system that utilizes light to detect a target position and acquire feature quantities such as a target distance, a target speed, and a target attitude. Typically, the LiDAR system may include a laser, a signal steering system, and a photodetector. The laser is configured to generate an optical pulse. The signal steering system is configured to direct the optical pulse emitted by the LiDAR system in a specific direction. The signal steering system may direct the emitted optical pulse along different paths to enable the LiDAR system to scan the surrounding environment. The optical pulse emitted by the LiDAR system is reflected or scattered after reaching a surrounding object. Some of the reflected or scattered light is returned to the LiDAR system as a returned signal. The signal steering system may also be configured to redirect the returned optical signal to the photodetector. The photodetector is configured to detect the returned optical signal. For example, the LiDAR system may determine the distance to the object along the path of the emitted optical pulse using the time taken to detect the returned optical signal after emitting the optical pulse and the speed of light. As is readily understood by those skilled in the art, the LiDAR system system may also utilize other techniques to measure the surrounding environment.

The “signal steering system” refers to a system that changes the direction of an optical signal. The signal steering system may include one or more optical redirecting elements (e.g., a rotating mirror or a galvanometer). The one or more optical redirecting elements steer the optical pulse along the emitting path to scan the external surroundings, for example, by rotation, vibration or guidance. The signal steering system may further include one or more optical redirecting elements (e.g., a rotating mirror or a lens). The one or more optical redirecting elements steer the optical signal along the receiving path to direct the returned optical signal to the photodetector, for example, by rotation, vibration or guidance. The optical redirecting elements that direct the optical signal along the emitting and receiving paths may be the same component (e.g., a shared component), a discrete component (e.g., a dedicated component), and/or a combination of shared and discrete components. These optical redirecting elements may include, for example, a galvanometer, a rotating mirror (such as a rotating polyhedral mirror), or a fixed mirror to steer the emitted pulse light or the received returned signal to different directions. In addition, the optical redirecting element further includes a motor for driving the optical redirecting element. The “rotating mirror” refers to an optical element that steers the optical pulse or the optical signal by the rotational motion of the mirror. In some examples, the rotating mirror is configured to be capable of rotating clockwise or counterclockwise for at least one revolution, for example, to achieve scanning of one or more signals in a horizontal direction of the LiDAR system. The “galvanometer” refers to an optical element that steers the optical pulse or the optical signal by the vibrational motion of the mirror. In some examples, the galvanometer is configured to be capable of making a pitching motion by a predetermined angle, for example, to achieve scanning of one or more signals in a vertical direction of the LiDAR system.

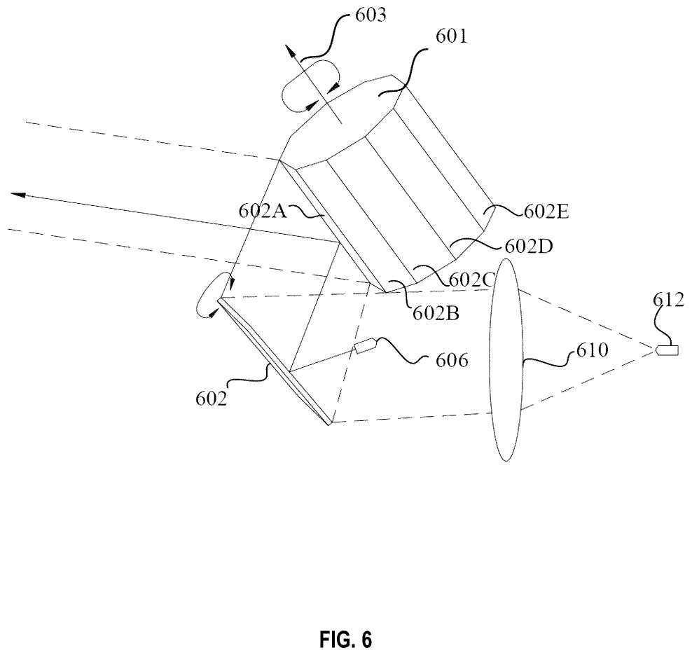

FIG. 6 illustrates a signal steering system according to some embodiments of the present disclosure. The signal steering system includes a rotating mirror and a galvanometer. In the embodiment shown in FIG. 6, the rotating mirror 601 has ten reflective side surfaces, but it can be understood that the rotating mirror may have any number of reflective side surfaces, for example, the rotating mirror 601 has 6, 8, or 20 side surfaces in other examples. The rotating mirror rotates about a shaft 603 based on a driving motor (not shown) to scan the signal transmitted from the laser as a light source along a direction perpendicular to or at a non-zero angle to the rotating shaft 603. The galvanometer 602 is located beside the rotating mirror 601, such that one or more signals emitted from a light source (e.g., a laser) are reflected from the galvanometer 602 to the rotating mirror 601. The galvanometer 602 can be tilted to scan one or more signals from the light source in a direction different from the signal scanning direction of the rotating mirror 601. In some examples, the rotating mirror 601 is responsible for scanning one or more signals in the horizontal direction of the LiDAR system system, and the galvanometer 602 is responsible for scanning one or more signals in the vertical direction. In some other examples, the rotating mirror 601 and the galvanometer 602 are configured in an opposite way. Although the galvanometer is used in the example of FIG. 6, other components may also be used instead. For example, one or more rotating mirrors or optical gratings (with pulses of different wavelengths) may be used. The black solid line represents an example signal path through the signal steering system.

Light returned by scattering (e.g., when light hits an object) of a signal in a region (indicated by the dashed line) returns to the rotating mirror 601, is reflected back to the galvanometer 602, and is focused by a lens to the detector. Although the lens is depicted as a single lens, in some variations, it is a system of one or more optical devices.

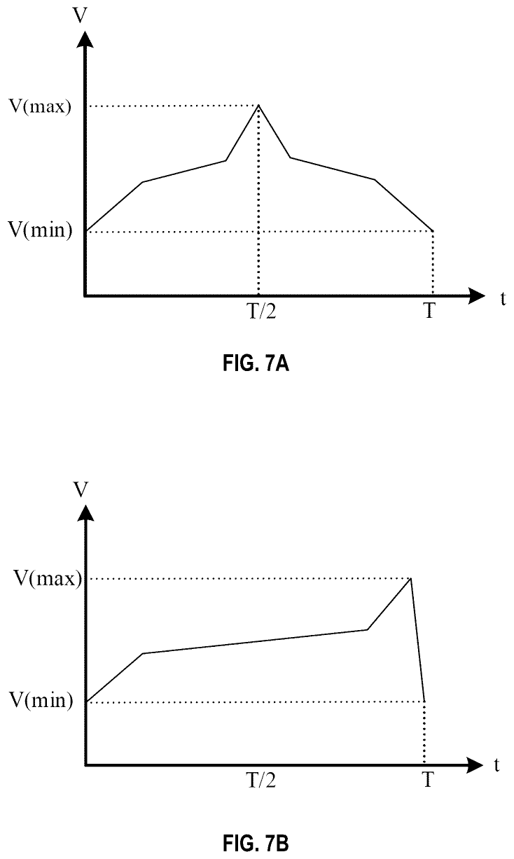

In a conventional LiDAR system, there are few laser sources, low vertical angular resolution, and a small region of interest (ROI). Even if the optical redirecting element stops rotating, the power of a laser beam emitted by the LiDAR system is much higher than a laser safety threshold, such as a human eye safety threshold. In some novel LiDAR systems, there are a large number of laser sources, the vertical angular resolution is only 0.5°, and the ROI is large, such that the optical power within the same distance and regional range is relatively increased. Although it is also within a safety standard, when the optical redirecting element stops moving for more than a certain time, the power of laser beams accumulatively emitted by the LiDAR system may still exceed a laser safety threshold within the same distance and regional range. In addition, FIG. 7A and FIG. 7B are diagrams illustrating curves of output voltages and time of a galvanometer motor of the LiDAR system in FIG. 6 in two working modes, where the output voltage is corresponding to the rotational position of the output shaft of the galvanometer motor. Referring to FIG. 7A and FIG. 7B, due to the fact that the LiDAR system has multiple working modes, extreme output voltages of the motor for driving the galvanometer and curves of voltages changing over time are different in different working modes, which further increases the difficulty of detecting the fault of the optical redirecting element.

According to an embodiment of the present disclosure, a detection circuit for a LiDAR system is proposed, which can reliably detect whether the optical redirecting element (e.g., a rotating mirror or a galvanometer) of the LiDAR system fails, and is applicable to the LiDAR system in various working modes. The detection circuit includes: an input terminal configured to receive a first signal for representing position information of a motor or an optical redirecting element; an output terminal configured to be connected to a laser; a detection signal generation unit configured to generate a detection signal based on the first signal; and a control unit configured to determine whether the motor or the optical redirecting element fails based on a comparison between the detection signal and a preset signal threshold, and output a control signal via the output terminal to control the laser.

In some embodiments of the present disclosure, the optical redirecting element includes at least one of a rotating mirror and a galvanometer, and the motor correspondingly includes at least one of a rotating mirror motor for driving the rotating mirror and a galvanometer motor for driving the galvanometer. In some examples, examples of the galvanometer motor for driving the galvanometer include but are not limited to various types of flux motors, such as axial flux motors (also known as axial flux electric motors, axial gap motors, or flat motors), and radial flux motors.

In some examples, the optical redirecting element further includes at least one position encoder.

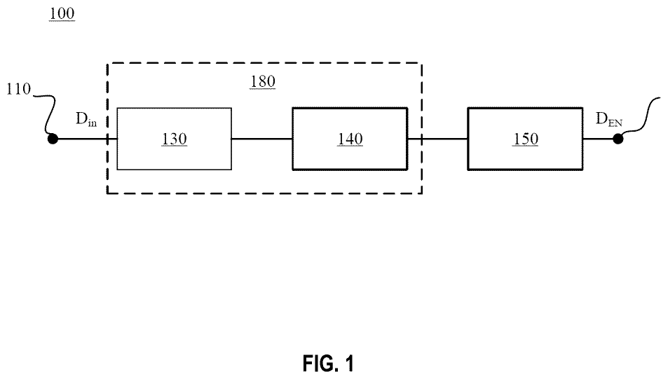

In one or more examples where the optical redirecting element includes a galvanometer, a first position encoder and the above galvanometer motor for driving the galvanometer are coupled to a mounting shaft of the galvanometer separately, the galvanometer is driven by the galvanometer motor to deflect around the mounting shaft, and the first position encoder rotates together with the mounting shaft to provide an output corresponding to the deflection of the mounting shaft of the galvanometer. For example, the first position encoder may be a rotary encoder that converts the angular position or motion of the mounting shaft into an electrical signal. The electrical signal can be transmitted as the first signal Din to the input terminal (such as the input terminal 110 in FIG. 1).

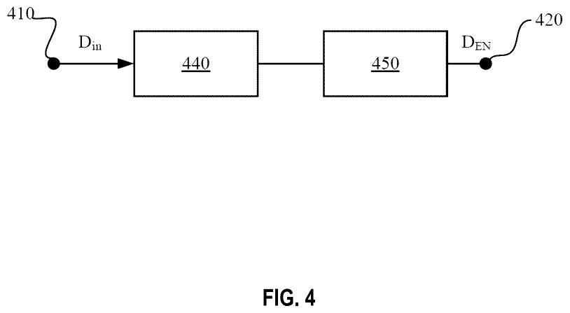

In one or more examples where the optical redirecting element includes a rotating mirror, a second position encoder is connected to a rotating structure of the rotating mirror and rotates together with the rotating mirror to provide an output indicating a rotational state and/or parameters of the rotating mirror. In some examples, the second position encoder includes an annular wall with a notch, and the notch can transmit the optical signal for exporting the rotational state and/or the parameters of the rotating mirror. For example, when the rotating mirror rotates a full circle to the position of the notch, the optical signal blocked by the annular wall can ride through the notch. Therefore, it is possible to confirm the rotational state of the rotating mirror and calculate the rotational speed of the rotating mirror by tracking interval time between two consecutive optical signals riding through the notch. The optical signal output of the second position encoder can be converted into an electrical signal. In a normal working state of the rotating mirror, the second position encoder generates an optical pulse within each cycle of rotation of the rotating mirror, and the pulse width of each optical pulse is basically the same. That is, in the normal working state of the rotating mirror, the optical signal output of the second position encoder will be converted into a uniform square wave signal. The square wave signal can be transmitted as the first signal Din to the input terminal (such as the input terminal 410 in FIG. 4).

In some other examples, instead of the signal outputted by at least one position encoder, the first signal Din may be a galvanometer motor output voltage signal for representing the rotational position of the galvanometer motor, or a rotating mirror motor output voltage signal for representing the rotational position of the rotating mirror motor. If the motor for driving the optical redirecting element, such as the galvanometer motor or the rotating mirror motor, fails, the optical redirecting element will also fail.

FIG. 1 is a schematic block diagram illustrating a detection circuit 100 for a LiDAR system according to some embodiments of the present disclosure. As shown in FIG. 1, the detection circuit may include an input terminal 110, an output terminal 120, a detection signal generation unit 180, and a control unit 150. The input terminal 110 can be configured to receive a first signal Dᵢₙ for representing rotational position information of a motor or an optical redirecting element. The output terminal 120 can be configured to be connected to a laser (not shown in FIG. 1). The detection signal generation unit is configured to generate a detection signal based on the first signal Dᵢₙ. The control unit 150 is configured to determine whether the motor or the optical redirecting element fails based on a comparison between the detection signal and a preset signal threshold, and output a control signal via the output terminal to control the laser.

If the motor or the optical redirecting element does not fail, the laser is controlled to remain on. If the motor or the optical redirecting element fails, the laser is controlled to be reduced in power, be decreased in emitting quantity, or be off.

In some embodiments, the detection signal generation unit 180 includes a charging and discharging unit 140. The charging and discharging unit 140 is configured to perform charging and discharging based on the first signal Dᵢₙ, and output a generated charging and discharging signal (such as a charging voltage detected at an output terminal of the charging and discharging unit) as the detection signal to the control unit 150. Further, the charging and discharging unit 140 is configured to perform discharging during one of pulse time and non-pulse time of a pulse signal formed based on the first signal, and perform charging during the other thereof.

In order to form the pulse signal based on the first signal, the detection signal generation unit 180 further includes a pulse signal generation unit 130. The pulse signal generation unit 130 can be configured to generate the pulse signal based on a comparison between the first signal Dᵢₙ and a pass-through comparison signal D_{HC} between a maximum value and a minimum value of the first signal. For example, when the value of the first signal is less than the value of the pass-through comparison signal, that is, the pass-through comparison signal rides through a falling edge of the first signal each time, the pulse signal generation unit 130 generates a pulse, and vice versa. The charging and discharging unit 140 can be configured to perform discharging during one of the pulse time and the non-pulse time of the pulse signal, and perform charging during the other thereof. The control unit 150 can be configured to determine whether the motor or the optical redirecting element fails based on a comparison between a charging voltage of the charging and discharging unit and a preset threshold voltage V_{TH}, and output a control signal via the output terminal to control the laser (such as to turn on or off the laser, to adjust the emitting power of the laser, or to control the emitting quantity of the laser). For example, when the motor or the optical redirecting element works normally, an enable signal D_{EN} is outputted to the laser via the output terminal, such that the enable signal D_{EN} is at a high level to turn on the laser; and when the motor or the optical redirecting element fails, the enable signal D_{EN} is at a low level to turn off the laser.

Through the detection circuit above, the fault of the optical redirecting element of the LiDAR system can be accurately and reliably detected without considering the working mode of the motor for driving the optical redirecting element of the LiDAR system. In the detection circuit according to an embodiment of the present disclosure, when the optical redirecting element fails, the fault can be accurately and reliably detected to turn off the laser in a timely manner, thereby preventing the cumulative optical power of the laser from exceeding the safety threshold of the LiDAR system.

In the embodiment of the present disclosure, the fault of the optical redirecting element or the motor of the LiDAR system includes stalling for more than a set time, or rotating at a rotational speed lower than a set threshold for more than a set time.

In some embodiments, when the value of the first signal is less than the value of the pass-through comparison signal, that is, the pass-through comparison signal rides through a falling edge of the first signal each time, the pulse signal generation unit 130 generates a pulse, and vice versa. If it is detected that the pass-through comparison signal rides through a falling edge of the first signal (i.e., downward pass-through occurs), then a rising edge is outputted and a high level is maintained. If it is detected that the pass-through comparison signal rides through a rising edge of the first signal (i.e., upward pass-through occurs), a falling edge is correspondingly generated, thereby forming a pulse. If no upward pass-through is detected within a set pulse width time, then a falling edge is forcibly generated, thereby forming a pulse.

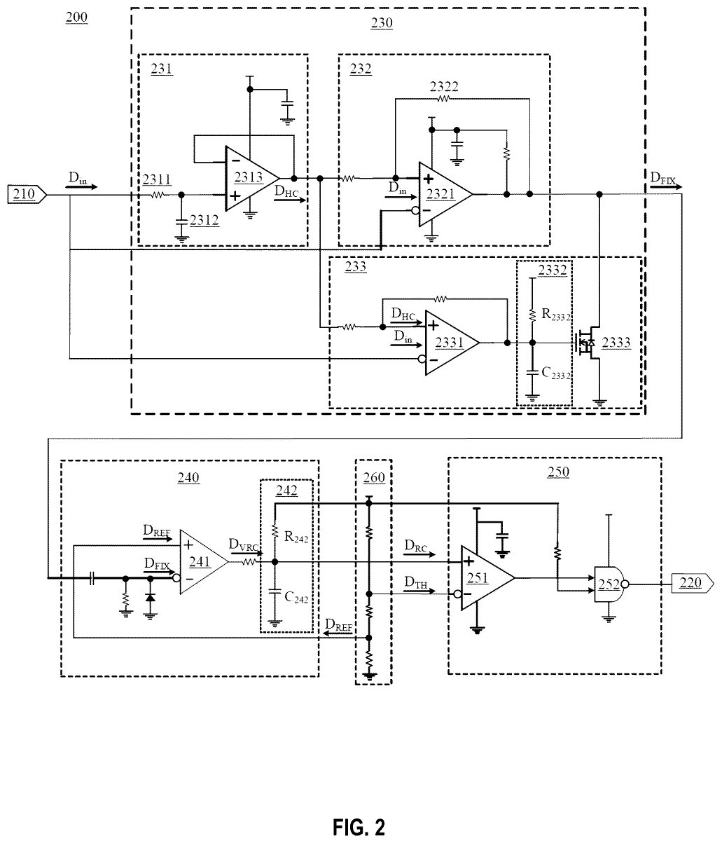

FIG. 2 is a schematic circuit diagram illustrating a detection circuit 200 for a LiDAR system according to some embodiments of the present disclosure.

Referring to FIG. 2, a pulse signal generation unit 230 includes a pass-through comparison signal generation circuit. The pass-through comparison signal generation circuit may be a direct-current component extraction circuit, preferably a low-pass filter 231. The low-pass filter 231 is connected to an input terminal 210 and configured to extract a direct-current component from the first signal Dᵢₙ, and the direct-current component is used as the pass-through comparison signal.

In some examples, the low-pass filter 231 is configured to receive the first signal Dᵢₙ (e.g., the first signal is the galvanometer motor output voltage signal, and when the galvanometer motor works normally, the rotational position of the output shaft of the galvanometer motor periodically changes, and the first signal is a periodically changing signal) for representing the rotational position information of the motor or the optical redirecting element, and collect and output the direct-current component therein. Through the low-pass filter 231, the direct-current component can be extracted from any periodically changing first signal Dᵢₙ. The amplitude of the direct-current component is approximately an average value of the amplitude of the first signal Dᵢₙ, and therefore it must be between a maximum value and a minimum value of a waveform of the first signal Dᵢₙ. Accordingly, as long as the motor for driving the optical redirecting element operates and the optical redirecting element operates normally, the direct-current component extracted by the low-pass filter 231 will be subjected to a pass-through comparison with the first signal Dᵢₙ and generate a pulse signal. The first signal Dᵢₙ is used for representing the periodic change of the rotational position of the motor or the optical redirecting element.

The low-pass filter may be, for example, an active low-pass filter, a passive low-pass filter, or any other filter that can collect a direct-current component in the motor output voltage signal. In the embodiment shown in FIG. 2, the low-pass filter 231 is an active low-pass filter. As shown in FIG. 2, the low-pass filter 231 includes a first resistor 2311, a first capacitor 2312, and a first operational amplifier 2313, where the first resistor 2311 has one end connected to the input terminal 210 of the detection circuit and the other end connected to an input terminal of the first operational amplifier 2313, and the first capacitor 2312 has one end connected to the first resistor 2311 and the other end connected to the ground.

In some examples, the first operational amplifier 2313 has a non-inverting input terminal, an inverting input terminal, and an output terminal, where the non-inverting input terminal of the first operational amplifier 2313 is connected to the first resistor 2311, and the output terminal of the first operational amplifier 2313 is connected to the inverting input terminal, thereby forming a negative feedback path. By using the active low-pass filter, signals from zero to a certain cutoff frequency can be allowed to ride through without attenuation, and signals at other frequencies can be suppressed, such that high-frequency interference signals can be filtered.

According to some embodiments of the present disclosure, the pulse signal generation unit 230 further includes a first comparator 232 configured to compare the pass-through comparison signal D_{HC} with the first signal Dᵢₙ. One of a non-inverting input terminal and an inverting input terminal of the first comparator 232 is configured to receive the pass-through comparison signal D_{HC}. For this, the one of the non-inverting input terminal and the inverting input terminal of the first comparator 232 is, for example, connected to an output terminal of the low-pass filter 231, namely the output terminal of the first operational amplifier 2313, to receive the direct-current component extracted from the first signal Dᵢₙ and used as the pass-through comparison signal D_{HC}; and the other of the non-inverting input terminal and the inverting input terminal of the first comparator 232 is connected to the input terminal 210, to receive the first signal Dᵢₙ.

In some examples, referring to FIG. 2, the non-inverting input terminal of the first comparator 232 is connected to the output terminal of the low-pass filter 231 to receive the pass-through comparison signal D_{HC} generated by the low-pass filter 231, namely the direct-current component extracted from the first signal Dᵢₙ, and the inverting input terminal is connected to the input terminal 210 of the detection circuit, to receive the first signal Dᵢₙ. By the first comparator 232, the pass-through comparison signal D_{HC} is compared with the first signal Dᵢₙ, and a comparison result is outputted. For example, if the pass-through comparison signal D_{HC} is smaller than the first signal Dᵢₙ, the first comparator 232 outputs a low level; or if the pass-through comparison signal D_{HC} is larger than the first signal Dᵢₙ, the first comparator 232 outputs a high level.

In some examples, the first comparator 232 is implemented as a hysteresis comparator. Referring to FIG. 2, the first comparator 232 includes a single-limit comparator 2321 and a hysteresis resistor 2322 to form a hysteresis comparator. The hysteresis resistor 2322 is connected between an output terminal and a non-inverting input terminal of the single-limit comparator 2321, and an output terminal of the single-limit comparator 2321 is connected to the non-inverting input terminal of the single-limit comparator 2321 through the hysteresis resistor 2322, to form a positive feedback path, thereby providing a positive feedback when an output of the single-limit comparator 2321 changes. For the single-limit comparator, if there is any small change in an input signal near a threshold value, whether the small change comes from the input signal or external interference, a leap in an output voltage will be caused. The positive feedback is introduced in the single-limit comparator to form the hysteresis comparator, which can overcome this shortcoming and reduce the sensitivity to the external interference.

In the embodiment of the present disclosure, the pulse signal generation unit 230 further includes a pulse signal shaping circuit 233. The pulse signal shaping circuit 233 can be configured to lock the pulse width of at least each pulse in the pulse signal to a fixed width.

In some examples, the pulse signal shaping circuit 233 includes a comparator 2331, a second RC charging and discharging circuit 2332, and a metal oxide semiconductor field-effect transistor (MOSFET) 2333. The comparator 2331 has a non-inverting input terminal, an inverting input terminal, and an output terminal. The non-inverting input terminal is connected to the output terminal of the low-pass filter 231 (see FIG. 2, for example, connected to the output terminal of the first operational amplifier 2313 of the active low-pass filter) to receive the pass-through comparison signal D_{HC}. The inverting input terminal is connected to the input terminal 210 of the detection circuit to receive the first signal Dᵢₙ. The output terminal is connected to the non-inverting input terminal of the comparator 2331 via a resistor to form a positive feedback. The comparator 2331 is configured to compare the pass-through comparison signal D_{HC} (see FIG. 2, for example, the direct-current component extracted from the first signal by the low-pass filter) with the first signal Dᵢₙ to obtain a first pass-through point in each cycle of the first signal, that is, a point where the pass-through comparison signal D_{HC} rides through the first signal for the first time in each cycle of the first signal Dᵢₙ. One end of a second capacitor C2332 of the second RC charging and discharging circuit 2332 is connected to the output terminal of the comparator 2331. The MOSFET has a gate, a source, and a drain. The gate is connected to one end of the second capacitor C2332 of the second RC charging and discharging circuit 2332. The source is connected to the ground. The drain is connected to the output terminal of the first comparator 232. The pulse width signal shaping circuit 233 is configured to charge the second RC charging and discharging circuit 2332 from the first pass-through point of the pass-through comparison signal D_{HC} and the first signal Dᵢₙ. When a set level is reached by charging, the MOSFET is turned on, such that a high level outputted by the pulse signal shaping circuit is converted into a low level. The charging time of the second RC charging and discharging circuit 2332 is determined by parameters of its resistor and capacitor. The pulse signal shaping circuit shapes a signal with a variable pulse width outputted by the first comparator 232 into a signal with a fixed pulse width, where the pulse width of each pulse of the signal with the fixed pulse width depends on the charging time of the second RC charging and discharging circuit 2332.

Further, in some examples, the second RC charging and discharging circuit 2332 of the pulse width signal shaping circuit 233 includes a second resistor R₂₃₃₂ and a second capacitor C₂₃₃₂. The second resistor R₂₃₃₂ has one end connected to the output terminal of the comparator 2331 and the other end connected to a reference power supply. The second capacitor C₂₃₃₂ has one end connected to the output terminal of the comparator 2331 and the other end connected to the ground.

An output terminal of the pulse width signal shaping circuit 233 is connected to an input terminal of a charging and discharging unit 240, so as to input a pulse signal D_{FIX} with the fixed pulse width to the charging and discharging unit 240.

According to the embodiment of the present disclosure, the detection circuit 200 further includes a threshold voltage generation unit 260. The threshold voltage generation unit 260 is configured to generate a threshold voltage signal D_{TH} and a reference voltage signal D_{REF}, transmit the generated reference voltage D_{REF} to the input terminal of the charging and discharging unit 240, and transmit the generated threshold voltage D_{TH} to an input terminal of a control unit 250. The threshold voltage generation unit 260 includes multiple resistors. A voltage of the reference voltage signal D_{REF} and a voltage of the threshold voltage signal D_{TH} can be set by allocating resistance values of different resistors.

According to the embodiment of the present disclosure, the charging and discharging unit 240 includes a third comparator 241 and a first RC charging and discharging circuit 242. According to the embodiment of the present disclosure, the charging and discharging unit 240 is configured to perform discharging within a duration corresponding to each pulse of the pulse signal D_{FIX} with the fixed pulse width, and perform charging in other time. Specifically, the pulse signal shaping circuit 233 inputs the pulse signal D_{FIX} with the fixed pulse width to an inverting input terminal of the third comparator 241 of the charging and discharging unit 240, and the threshold voltage generation unit 260 inputs the generated reference voltage D_{REF} to a non-inverting input terminal of the third comparator 241. When in the pulse of the pulse signal, the signal D_{FIX} inputted to the inverting input terminal of the third comparator 241 is larger than the reference voltage signal D_{REF} inputted to the non-inverting input terminal, and an output signal D_{VRC} is at a low level, such that a capacitor C₂₄₂ in the first RC charging and discharging circuit 242 discharges to the ground, and the value of an output signal D_{RC} of the first RC charging and discharging circuit 242 decreases. When in the non-pulse phase of the pulse signal, the signal D_{FIX} inputted to the inverting input terminal of the third comparator 241 is smaller than the reference voltage signal D_{REF} inputted to the non-inverting input terminal, and the output signal D_{VRC} is at a high level, such that the capacitor C₂₄₂ in the first RC charging and discharging circuit 242 is charged, and the value of the output signal DRC of the first RC charging and discharging circuit 242 increases. Therefore, if the signal steering system or the motor fails, then no pulse signal is generated correspondingly, the first RC charging and discharging circuit 242 remains in a charging state, and the output signal D_{RC} of the first RC charging and discharging circuit 242 will exceed the threshold voltage D_{TH}.

According to the embodiment of the present disclosure, the control unit 250 includes a second comparator 251. The second comparator 251 is configured to compare a charging voltage DRC of the charging and discharging unit with a threshold voltage D_{TH} as the signal threshold, and control output of an enable signal or invert the enable signal in response to a comparison result of the charging voltage and the threshold voltage. Referring to FIG. 2, a non-inverting input terminal of the second comparator 251 is connected to the charging voltage DRC of the charging and discharging unit 240, an inverting input terminal of the second comparator 251 is connected to the threshold voltage D_{TH}, and an output of the second comparator 251 is inverted to control the enable signal D_{EN}, such that in response to the charging voltage DRC exceeding the threshold voltage D_{TH}, the enable signal D_{EN} is inverted to be at a low level to turn off the laser.

According to some embodiments, the threshold voltage is set based on allowed motor fault time. The motor failure time can be configured based on the requirements of the LiDAR system system and the requirements of relevant safety thresholds.

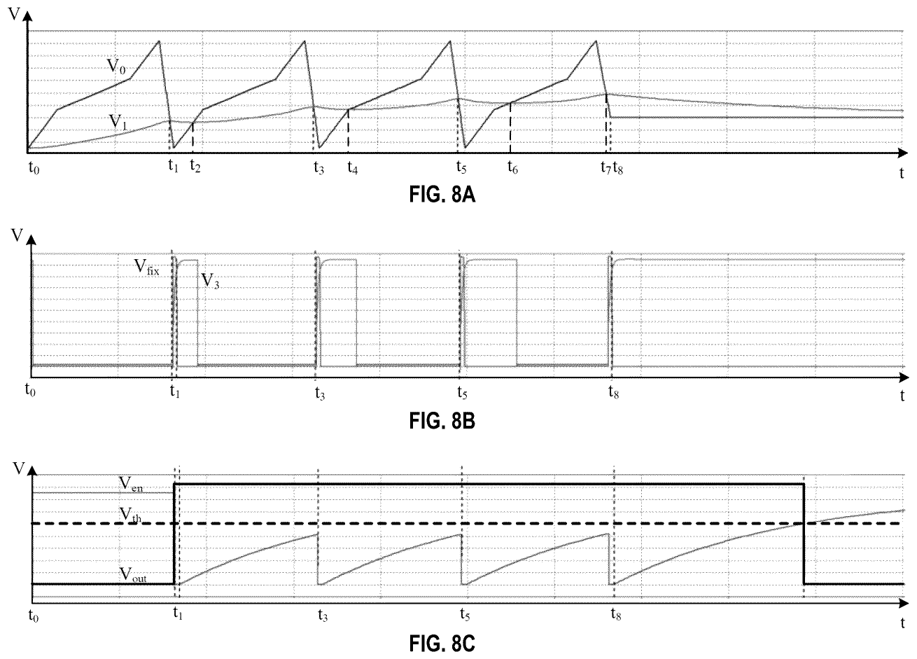

FIG. 8A to FIG. 8C are schematic diagrams of simulation results of the detection circuit for the LiDAR system shown in FIG. 2. The circuit shown in FIG. 2 is configured to detect whether the galvanometer motor of the LiDAR system fails. The galvanometer motor output voltage for representing the position of the galvanometer motor is used as the input of the circuit shown in FIG. 2, namely the first signal Dᵢₙ.

In FIG. 8A, the galvanometer motor output voltage V₀ for representing the position of the galvanometer motor is shown. The galvanometer motor output voltage periodically changes with time from t₀ to t₈, and remains unchanged after the time point t₈, meaning that the galvanometer motor stops rotating. In FIG. 8A, an approximate direct-current component V₁ of the galvanometer motor output voltage outputted after filtration via the low-pass filtering unit 130 is further shown as the pass-through comparison signal. The direct-current component V₁ of the galvanometer motor output voltage is subjected to a pass-through comparison with the galvanometer motor output voltage V₀. For example, at the time point t₁, when the galvanometer motor output voltage V₀ is lower than the direct-current component V₁ of the galvanometer motor output voltage, that is, the direct-current component V₁ of the galvanometer motor output voltage rides through a falling edge of the galvanometer motor output voltage V₀ to form downward pass-through. After that, when the galvanometer motor output voltage V₀ is lower than the direct-current component V₁ of the galvanometer motor output voltage each time, that is, at the falling edge of the galvanometer motor output voltage V₀ within each cycle, for example, at the time points t₃, t₅, and t₇, downward pass-through will occur. The motor stops rotating after the time point t₈, such that the direct-current component V₁ of the galvanometer motor output voltage does not ride through the galvanometer motor output voltage Vo any more after the time point t₈.

In FIG. 8B, a pulse signal V₃ outputted via the first comparator and a pulse signal V_{fix} outputted via the pulse signal shaping circuit are shown. When the direct-current component V₁ of the galvanometer motor output voltage signal V₀ is smaller than the galvanometer motor output voltage signal V₀, the first comparator outputs a low level. When the direct-current component V₁ of the galvanometer motor output voltage signal V₀ is larger than the galvanometer motor output voltage signal V₀, the first comparator outputs a high level. During the period in which the voltage signal V₁rides through the falling edge and the adjacent rising edge of the galvanometer motor output voltage Vo each time, for example, during the periods between t₁ and t₂, between t₃ and t₄, and between t₅ and t₆, the first comparator can generate a pulse signal. However, a pass-through point between the galvanometer motor output voltage signal V₀ and the direct-current component V₁ of the galvanometer motor output voltage is not fixed in each cycle of the galvanometer motor output voltage signal, so a pulse duty ratio of the pulse signal V₃ outputted via the first comparator in any cycle is uncertain. The fixed duty ratio of each pulse can be ensured by arranging the pulse signal shaping circuit. As shown by V_{fix} in FIG. 8B, the pulse signal with the fixed pulse width can be outputted via the pulse signal shaping circuit.

In FIG. 8C, the thick solid line represents an output voltage Vₒᵤₜ of the charging and discharging unit, the dashed line represents a threshold voltage Vₜₕ, and the gray solid line represents an enable signal Vₑₙ. During each pulse of the pulse signal with the fixed pulse width, the charging and discharging unit discharges. During the non-pulse period, the charging and discharging unit charges. As shown in FIG. 8C, starting from the time point t8, the galvanometer motor stops rotating, the charging and discharging unit will remain in the charging state, and the threshold voltage Vth is reached after the allowed motor failure time Tₛₑₜ. If the output voltage Vₒᵤₜ of the charging and discharging unit is lower than the threshold voltage Vₜₕ, then the enable signal Vₑₙ is at a high level. If the output voltage Vₒᵤₜ of the charging and discharging unit is higher than the threshold voltage Vₜₕ, then the enable signal Vₑₙ is inverted to be at a low level, so as to turn off the laser.

If the position of the motor for driving the optical redirecting element or the optical redirecting element periodically changes over time and the change of each cycle is uncertain, the embodiments of the detection circuits described with reference to FIG. 2 and FIGS. 8A to 8C can be used.

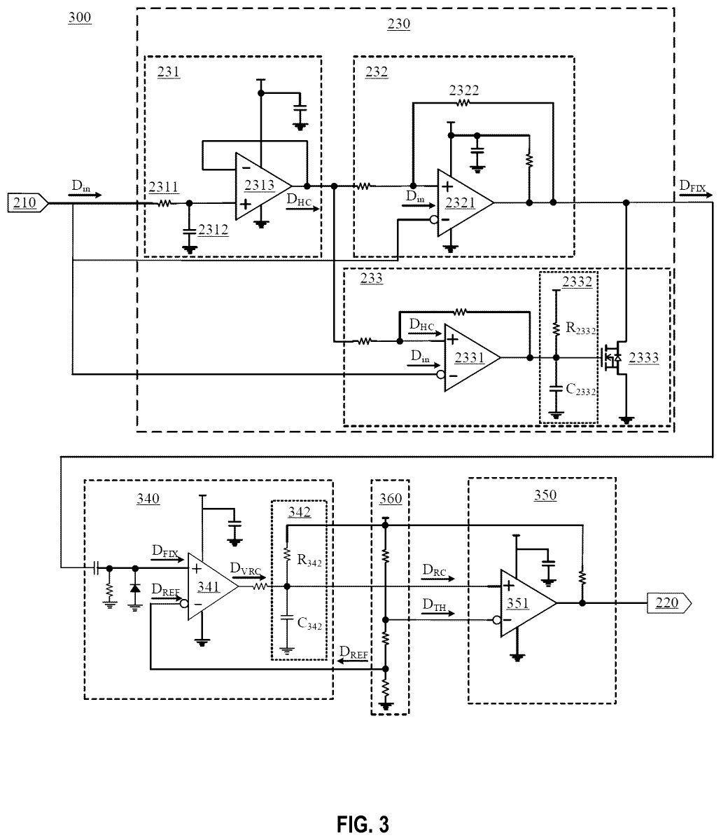

FIG. 3 is a schematic circuit diagram illustrating a detection circuit 300 for a LiDAR system according to some other embodiments of the present disclosure. In the embodiment shown in FIG. 3, the pulse signal generation unit 230 of the detection circuit and the low-pass filter 231, the first comparator 232, and the pulse signal shaping unit 233 of the pulse signal generation unit are the same as those in the embodiment shown in FIG. 2, so the same reference signs are used here and will not be described in detail.

In the embodiment shown in FIG. 3, a charging and discharging unit 340 is configured to perform discharging within a duration corresponding to each pulse of the pulse signal D_{FIX} with the fixed pulse width, and perform charging in other time. Specifically, the charging and discharging unit 340 includes a third comparator 341 and a first RC charging and discharging circuit 342. The pulse signal shaping circuit 233 inputs the pulse signal D_{FIX} with the fixed pulse width to a non-inverting input terminal of the third comparator 341 of the charging and discharging unit 340, and a threshold voltage generation unit 360 inputs the generated reference voltage D_{REF} to an inverting input terminal of the third comparator 341. When in the pulse of the pulse signal, the signal D_{FIX} inputted to the non-inverting input terminal of the third comparator 341 is higher than the reference voltage signal D_{REF} inputted to the inverting input terminal, and an output signal D_{VRC} is at a high level, such that a capacitor C₃₄₂ in the first RC charging and discharging circuit 342 discharges to the ground, and the value of an output signal D_{RC} of the first RC charging and discharging circuit 342 increases. When in the non-pulse phase of the pulse signal, the signal D_{FIX} inputted to the non-inverting input terminal of the third comparator 341 is lower than the reference voltage signal D_{REF} inputted to the inverting input terminal, and the output signal D_{VRC} is at a low level, such that the capacitor C₃₄₂ in the first RC charging and discharging circuit 342 is discharged, and the value of the output signal D_{RC} (a charging voltage) of the first RC charging and discharging circuit 342 decreases. Therefore, if the signal steering system or the motor fails, then no pulse signal is generated correspondingly, the first RC charging and discharging circuit 342 remains in a discharging state, and the output signal D_{RC} of the first RC charging and discharging circuit 342 will be lower than the threshold voltage D_{TH}.

Similar to the embodiment shown in FIG. 2, in the embodiment shown in FIG. 3, the detection circuit 300 may include a control unit 350. The control unit 350 is connected to the output terminal 220 of the detection circuit 300. A non-inverting input terminal of a second comparator 351 of the control unit 350 is connected to the charging voltage D_{RC} of the charging and discharging unit 340, an inverting input terminal of the second comparator 351 is connected to the threshold voltage D_{TH}, and an output of the second comparator 351 is configured to control the enable signal D_{EN}, such that in response to the charging voltage D_{RC} lower than the threshold voltage D_{TH}, the enable signal D_{EN} is controlled to be inverted to be at a low level to turn off the laser.

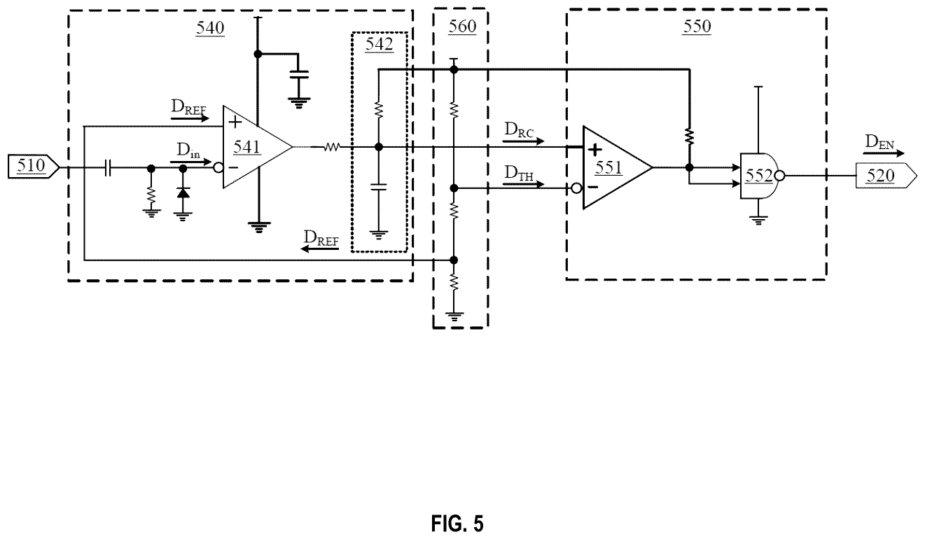

According to some other embodiments of the present disclosure, a detection circuit 400 for a LiDAR system is further provided, which can be configured to detect a fault of, for example, a rotating mirror or a rotating mirror motor. The detection circuit can detect stalling and low-speed rotation of the rotating mirror or the rotating mirror motor. As described above, the signal for representing the rotational state of the rotating mirror or the rotating mirror motor may be a pulse signal. FIG. 4 is a schematic block diagram illustrating a detection circuit for a LiDAR system according to some other embodiments of the present disclosure. FIG. 5 is a schematic circuit diagram illustrating a detection circuit for a LiDAR system according to some other embodiments of the present disclosure. The LiDAR system using such detection circuit includes a laser for emitting an optical signal, an optical redirecting element for redirecting the optical signal, and a motor for driving the optical redirecting element. The detection circuit includes an input terminal 410, an output terminal 420, a detection signal generation unit, and a control unit 450. The input terminal 410 is configured to receive a pulse signal for representing a rotational state of a motor or an optical redirecting element. The output terminal 420 is configured to be connected to a laser. The detection signal generation unit includes a charging and discharging unit 440 configured to perform discharging during one of pulse time and non-pulse time of the pulse signal, and perform charging during the other thereof. The control unit 450 is configured to determine whether the motor or the optical redirecting element fails based on a comparison between a charging voltage of the charging and discharging unit and a preset threshold voltage, and output a control signal via the output terminal to control the laser (such as to turn on or off the laser, to adjust the emitting power of the laser, or to control the emitting quantity of the laser). For example, the control unit 450 is configured to control an enable signal outputted to the laser via the output terminal based on whether the charging voltage of the charging and discharging unit is lower than the preset threshold voltage, so as to control the turn-on and turn off the laser.

As described above, in the normal working state of the rotating mirror, the second position encoder generates an optical pulse within each cycle of motion of the rotating mirror, and the pulse width of each optical pulse is basically the same. That is, in the normal working state of the rotating mirror, the optical signal output of the second position encoder will be converted into a uniform square wave signal. The square wave signal (the pulse signal) can be transmitted as the first signal Dᵢₙ to the input terminal 410. Because the pulse signal is a periodic signal with a basically constant pulse width, the pulse signal generation units and the low-pass filters, the first comparators, and the pulse signal shaping circuits thereof in the embodiments described with reference to FIG. 1 and FIG. 2 can be omitted. The pulse signal is directly transmitted to the charging and discharging unit 440 of the detection circuit 400 through the input terminal 410. Specifically, referring to FIG. 5, the pulse signal is directly inputted to an inverting input terminal of a comparator 541 of a charging and discharging unit 540 through an input terminal 510, such that the pulse signal is inputted to the comparator 541 of the charging and discharging unit 540.

According to the embodiment of the present disclosure, referring to FIG. 5, a control unit 550 includes a second comparator 551. A non-inverting input terminal of the second comparator 551 is connected to a charging voltage of the charging and discharging unit 540 (specifically, a first RC charging and discharging circuit 542), an inverting input terminal of the second comparator 551 is connected to a threshold voltage D_{TH} generated by a threshold voltage generation unit 560, and an output of the second comparator 551 is inverted (for example, by unit 552) to control the enable signal D_{EN}, such that in response to the charging voltage exceeding the threshold voltage D_{TH}, the enable signal D_{EN} is controlled to be inverted to output a low level to the laser.

According to some embodiments, the threshold voltage is set based on allowed motor fault time. The motor failure time can be configured based on the requirements of the LiDAR system system. For the motor or the optical redirecting element that rotates at a constant speed (such as the rotating mirror), or the motor or the optical redirecting element with the same motion cycle (such as the galvanometer), the pulse signal corresponding to the first signal should be a pulse signal with equal pulse width and interval. If it is detected that interval time between two adjacent pulses is too long, it means that the rotational speed within this cycle drops. It can be determined whether the motor or the optical redirecting element rotates at the rotational speed lower than the rotational speed threshold by detecting the interval time between the two pulses. The detection circuit above can detect whether the motor or the optical redirecting element stops rotating and whether the motor or the optical redirecting element rotates at a low speed. For example, it is possible to set allowed motor stalling time to 500 ms, and obtain a corresponding first threshold voltage reached by the charging and discharging unit in the allowed motor stalling time. In this case, when it is detected that the charging voltage of the charging and discharging unit exceeds the first threshold voltage, it means that the charging time of the charging and discharging unit exceeds the allowed stalling time, that is, the motor or the optical redirecting element stops rotating for more than 500 ms. The detection circuit can control the turn-off of the laser and reduce the frequency or the emitting quantity of the laser. For another example, based on an allowed lower speed limit, such as 1,200 revolutions per minute, allowed interval time between two adjacent pulses of the pulse signal corresponding to the first signal, such as 50 ms, can be obtained, and a second threshold voltage reached by the charging and discharging unit within the allowed interval time can be obtained. If it is detected that the charging voltage of the charging and discharging unit exceeds the second threshold voltage, it means that the motor or the optical redirecting element is rotating at a low speed. At this time, the detection circuit can control the turn-off of the laser and reduce the frequency or the emitting quantity of the laser.

In the embodiment above, the optical redirecting element is a rotating mirror, the motor is a rotating mirror motor for driving the rotating mirror, and each pulse in the pulse signal rotates once in corresponding to the cycle of the rotating mirror, for example, rotates for one revolution. It can be understood that the optical redirecting element capable of being represented by pulse signals at other positions or the motor for driving the optical redirecting element may also be applicable to the detection circuit 400 described with reference to FIG. 4.

According to another aspect of the present disclosure, a LiDAR system is provided, including the detection circuit according to any one of the embodiments above.

According to another aspect of the present disclosure, a vehicle system is provided, including the LiDAR system according to any one of the embodiments above. The vehicle system includes but is not limited to a vehicle, an unmanned aerial vehicle, a ship, etc. Its usage scenarios include but are not limited to roadside detection apparatuses, wharf monitors, intersection monitors, factories, and other systems with multiple sensors.

The vehicle system includes at least a LiDAR system as a sensor. The LiDAR system is synchronized with other sensors and/or components in the vehicle system through frame synchronization signals. In the vehicle system, for example, the LiDAR system can be used as a main control to send the frame synchronization signals, thereby being synchronized with other sensors in the vehicle system, such as cameras, millimeter wave radars, or other LiDAR systems. In the vehicle system, the frame synchronization signals can also be sent by, for example, a central control system to achieve synchronization between sensors (e.g., LiDAR systems, cameras, millimeter wave radars, etc.) or with other components in the vehicle system.

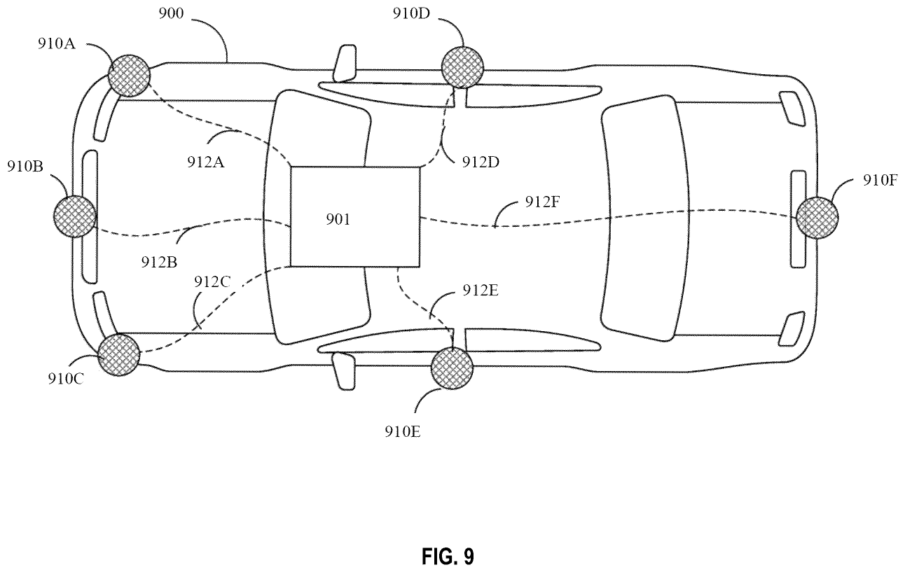

FIG. 9 illustrates an exemplary centralized laser transmission system 901 and multiple LiDAR systems 910A-F arranged or included in a vehicle system 900. It can be understood that the centralized laser transmission system 901 is only exemplary or other types of laser transmission systems may be used.

In some embodiments, depending on a state of the vehicle system 900, the centralized laser transmission system 901 can provide a laser signal to one or more of the multiple LiDAR systems 910A-F. For example, the vehicle system 900 may move forwards and thus objects located in front of and on two sides of the vehicle system 900 may need to be detected, but objects located behind the vehicle system 900 may not need to be detected. Therefore, the centralized laser transmission system 901 can provide the laser signal to the LiDAR systems 910A-E instead of the LiDAR system 910F. The LiDAR system 910F is configured to detect the objects located behind the vehicle system 900.

In some embodiments, the centralized laser transmission system 901 can provide the laser signal by using one or more channels 912A-F (collectively referred to as a channel 912).

For any of the multiple LiDAR systems 910A-F, the accuracy and reliability of fault detection of the rotating mirror and/or the galvanometer of the LiDAR system can be achieved by the detection circuit for a LiDAR system according to any one of the embodiments above.

According to another aspect of the present disclosure, a method 1000 for controlling a LiDAR system is provided. The LiDAR system includes a laser, an optical redirecting element, and a motor. The method includes:
S1010: acquiring a first signal for representing rotational position information of the motor or the optical redirecting element;
S1020: determining an operating state of the motor or the optical redirecting element based on the first signal; and
S1030: controlling the laser based on the operating state.

Through the control method, a working state of the laser can be controlled based on the operating state of the optical redirecting element or the motor of the LiDAR system. The control method above can be implemented by the detection circuit for a LiDAR system according to any one of the embodiments above, or by other hardware or software.

In some embodiments, the S1020 of determining an operating state of the motor or the optical redirecting element based on the first signal includes: determining whether the motor or the optical redirecting element fails based on the first signal.

In some embodiments, the S1030 of controlling the laser based on the operating state includes: controlling the laser based on whether the motor or the optical redirecting element fails. For example, in response to normal rotation of the motor or the optical redirecting element, the laser is controlled to remain on; and in response to a fault of the motor or the optical redirecting element, the laser is controlled to be reduced in power, be decreased in emitting quantity, or be off.

In some embodiments, the fault of the motor or the optical redirecting element includes rotating at a rotational speed lower than a set threshold or stalling for more than allowed time.

The following describes some exemplary solutions of the present disclosure.
Solution 1. A detection circuit for a Light Detection and Ranging (LiDAR) system, the LiDAR system comprising a laser, an optical redirecting element, and a motor, and the detection circuit including: an input terminal configured to receive a first signal for representing position information of a motor or an optical redirecting element; an output terminal configured to be connected to a laser; a detection signal generation unit configured to generate a detection signal based on the first signal; and a control unit configured to determine, based on a comparison between the detection signal and a preset signal threshold, whether the motor or the optical redirecting element fails, and output a control signal via the output terminal to control the laser.
Solution 2. The detection circuit according to solution 1, where the detection signal generation unit includes a charging and discharging unit configured to perform charging and discharging based on the first signal, and output a generated charging and discharging signal as the detection signal to the control unit.
Solution 3. The detection circuit according to solution 2, where the charging and discharging unit is configured to perform discharging during one of pulse time and non-pulse time of a pulse signal formed based on the first signal, and perform charging during the other thereof.
Solution 4. The detection circuit according to any one of solutions 1 to 3, where the detection signal generation unit further includes a pulse signal generation unit configured to generate the pulse signal based on a comparison between the first signal and a pass-through comparison signal between a maximum value and a minimum value of the first signal.
Solution 5. The detection circuit according to solution 4, where the pulse signal generation unit further includes a pulse signal shaping circuit configured to lock the pulse width of at least each pulse in the pulse signal to a fixed width.
Solution 6. The detection circuit according to solution 4 or 5, where the pulse signal generation unit further includes a low-pass filter connected to the input terminal and configured to extract a direct-current component from the first signal, and the direct-current component is used as the pass-through comparison signal.
Solution 7. The detection circuit according to solution 4, where the pulse signal generation unit further includes a first comparator, one of a non-inverting input terminal and an inverting input terminal of the first comparator is configured to receive the pass-through comparison signal, and the other of the non-inverting input terminal and the inverting input terminal of the first comparator is connected to the input terminal.
Solution 8. The detection circuit according to any one of solutions 2 to 7, where the control unit includes a second comparator configured to compare a charging voltage of the charging and discharging unit with a threshold voltage of the signal threshold, and control output of an enable signal or invert the enable signal in response to a comparison result of the charging voltage and the threshold voltage.
Solution 9. The detection circuit according to any one of solutions 1 to 8, where the preset threshold is set based on motor failure time allowed by safety standards.
Solution 10. The detection circuit according to any one of solutions 1 to 9, where the optical redirecting element is at least one of a rotating mirror and a galvanometer, and the motor includes at least one of a rotating mirror motor for driving the rotating mirror and a galvanometer motor for driving the galvanometer.
Solution 11. A LIDAR system, including the detection circuit according to any one of solutions 1 to 10.
Solution 12. A vehicle system, including the LiDAR system according to solution 11.
Solution 13. A method for controlling a LiDAR system, the LiDAR system including a laser, an optical redirecting element, and a motor, and the method including: acquiring a first signal for representing rotational position information of the motor or the optical redirecting element; determining an operating state of the motor or the optical redirecting element based on the first signal; and controlling the laser based on the operating state.
Solution 14. The method for controlling a LiDAR system according to solution 13, where the controlling the laser based on the operating state includes: in response to normal rotation of the motor or the optical redirecting element, controlling the laser to keep the laser on; and in response to a fault of the motor or the optical redirecting element, controlling the laser to be reduced power or turn the laser off.
Solution 15. The method for controlling a LiDAR system according to solution 14, where the fault includes rotating at a rotational speed lower than a rotational speed threshold or stalling longer than allowable time.

The above description is merely an explanation of preferred embodiments of the present disclosure and the technical principles applied. Those skilled in the art should understand that the scope of the invention involved in the embodiments of the present disclosure is not limited to technical solutions formed by specific combinations of the above technical features, and should also cover other technical solutions formed by any combination of the above technical features or their equivalent features without departing from the above inventive concept, for example, technical solutions formed by mutually replacing the above features with (but not limited to) technical features with similar functions disclosed in the embodiments of the present disclosure.

1-15. (canceled)

16. A detection circuit for a Light Detection and Ranging (LiDAR) system, the LiDAR system comprising a laser, an optical redirecting element, and a motor, and the detection circuit comprising:
an input terminal configured to receive a first signal representing position information of the motor or the optical redirecting element;
an output terminal configured to be connected to the laser;
a detection signal generation unit configured to generate a detection signal based on the first signal; and
a control unit configured to:
determine, based on a comparison between the detection signal and a preset signal threshold, whether the motor or the optical redirecting element fails, and
output a control signal via the output terminal to control the laser.

17. The detection circuit of claim 16, wherein the detection signal generation unit comprises:
a charging and discharging unit configured to:
perform charging and discharging based on the first signal, and
output a generated charging and discharging signal as the detection signal to the control unit.

18. The detection circuit of claim 17, wherein the charging and discharging unit is configured to:
perform discharging during one of pulse time and non-pulse time of a pulse signal formed based on the first signal, and
perform charging during the other of the pulse time and non-pulse time of the pulse signal.

19. The detection circuit of claim 16, wherein the detection signal generation unit further comprises:
a pulse signal generation unit configured to generate a pulse signal based on a comparison between the first signal and a pass-through comparison signal that is between a maximum value and a minimum value of the first signal.

20. The detection circuit of claim 19, wherein the pulse signal generation unit further comprises:
a pulse signal shaping circuit configured to lock a pulse width of each pulse in the pulse signal to a fixed width.

21. The detection circuit of claim 19, wherein the pulse signal generation unit further comprises:
a low-pass filter connected to the input terminal and configured to extract a direct-current component from the first signal, wherein the direct-current component is used as the pass-through comparison signal.

22. The detection circuit of claim 19, wherein the pulse signal generation unit further comprises:
a first comparator, one of a non-inverting input terminal and an inverting input terminal of the first comparator being configured to receive the pass-through comparison signal, and the other of the non-inverting input terminal and the inverting input terminal of the first comparator being connected to the input terminal.

23. The detection circuit of claim 17, wherein the control unit comprises:
a second comparator configured to compare a charging voltage of the charging and discharging unit with a threshold voltage of the preset signal threshold, and control output of an enable signal or invert the enable signal in response to a comparison result of the charging voltage and the threshold voltage.

24. The detection circuit of claim 23, wherein the threshold voltage is set based on an allowed motor failure time.

25. The detection circuit of claim 16, wherein outputting the control signal via the output terminal to control the laser comprises one of turning the laser off, reducing frequency of the laser, and reducing emitting quantity of the laser.

26. The detection circuit of claim 16, wherein the optical redirecting element is at least one of a rotating mirror and a galvanometer, and wherein the motor comprises at least one of a rotating mirror motor for driving the rotating mirror and a galvanometer motor for driving the galvanometer.

27. A LiDAR system, comprising
a laser,
an optical redirecting element,
a motor, and
a detection circuit comprising:
an input terminal configured to receive a first signal representing position information of the motor or the optical redirecting element;
an output terminal configured to be connected to the laser;
a detection signal generation unit configured to generate a detection signal based on the first signal; and
a control unit configured to:
determine, based on a comparison between the detection signal and a preset signal threshold, whether the motor or the optical redirecting element fails, and
output a control signal via the output terminal to control the laser.

28. A vehicle system, comprising:
a LiDAR system, comprising:
a laser,
an optical redirecting element,
a motor, and
a detection circuit comprising:
an input terminal configured to receive a first signal representing position information of the motor or the optical redirecting element;
an output terminal configured to be connected to the laser;
a detection signal generation unit configured to generate a detection signal based on the first signal; and
a control unit configured to:
determine, based on a comparison between the detection signal and a preset signal threshold, whether the motor or the optical redirecting element fails, and
output a control signal via the output terminal to control the laser.

29. A method for controlling a LiDAR system, the LiDAR system comprising a laser, an optical redirecting element, and a motor, the method comprising:
acquiring a first signal for representing rotational position information of the motor or the optical redirecting element;
determining an operating state of the motor or the optical redirecting element based on the first signal; and
controlling the laser based on the operating state.

30. The method for controlling a LiDAR system of claim 29, wherein controlling the laser based on the operating state comprises:
in response to normal rotation of the motor or the optical redirecting element, controlling the laser to keep the laser on; and
in response to a fault of the motor or the optical redirecting element, controlling the laser to reduce power or turn the laser off.

31. The method for controlling a LiDAR system of claim 30, wherein the fault includes rotating at a rotational speed lower than a rotational speed threshold or stalling longer than an allowable time.
